(19) United States
(12) Patent Application Publication
(10) Pub. No.: US 2024/0165817 A1
(43) Pub. Date: May 23, 2024

(54) ROBOT MANAGEMENT DEVICE, CONTROL METHOD, AND RECORDING MEDIUM

(71) Applicant: NEC Corporation, Minato-ku, Tokyo (JP)

(72) Inventors: Hisaya WAKAYAMA, Tokyo (JP); Masatsugu OGAWA, Tokyo (JP); Masumi ICHIEN, Tokyo (JP); Takehiro ITOU, Tokyo (JP)

(73) Assignee: NEC Corporation, Minato-ku, Tokyo (JP)

(21) Appl. No.: 18/285,025

(22) PCT Filed: Apr. 9, 2021
(86) PCT No.: PCT/JP2021/015053

§ 371 Date: Sep. 29, 2023

(51) Int. Cl. B25J 9/16; G06Q 10/0639

(52) U.S. Cl. CPC B25J 9/1689; B25J 9/1653; B25J 9/1669; G06Q 10/06398

(57) ABSTRACT

A robot management device 3X mainly includes an external input necessity determination means 35X and an operation terminal determination means 36X. The external input necessity determination means 35X determines whether or not a control based on an external input is necessary for a robot which executes a task. The operation terminal determination means 36X determines an operation terminal which generates the external input, based on operation terminal information, which includes information concerning types of a plurality of operation terminals to be candidates in order to generate the external input, and information concerning the task, when the control based on the external input is necessary.

### TECHNICAL FIELD

The present disclosure relates to a technical field of controlling an action of a robot.

### BACKGROUND ART

A robot system has been proposed in which a part of a task is executed based on an external input by a person when a robot executes the task. For example, Patent Document 1 discloses a robot system which requests a remote control to an operation terminal operated by an operator when it becomes infeasible by an autonomous control alone.

### PRECEDING TECHNICAL REFERENCES

### Patent Document

Patent Document 1: Japanese Laid-open Patent Publication No. 2007-190659

### SUMMARY

### Problem to be Solved by the Invention

In a case where a robot is operated based on an external input, a necessary operation differs depending on an action content. On the other hand, a robot system described in Patent Document 1 is an interactive robot and does not consider the variety of operation methods in a case of selecting one operation terminal.

In view of the problems described above, it is one object of the present disclosure to provide a robot management device, a control method, and a recording medium which can preferably determine an operation terminal for generating the external input.

### Means for Solving the Problem

According to an example aspect of the present disclosure, there is provided a robot management device including:
an external input necessity determination means configured to determine whether or not a control based on an external input is necessary for a robot which executes a task; and
an operation terminal determination means configured to determine an operation terminal which generates the external input, based on operation terminal information, which includes information concerning types of a plurality of operation terminals to be candidates in order to generate the external input, and information concerning the task, when the control based on the external input is necessary.

According to another example aspect of the present disclosure, there is provided a control method performed by a computer, the control method including:
determining whether or not a control based on an external input is necessary for a robot which executes a task; and
determining an operation terminal which generates the external input, based on operation terminal information, which includes information concerning types of a plurality of operation terminals to be candidates in order to generate the external input, and information concerning the task, when the control based on the external input is necessary.

According to a further example aspect of the present disclosure, there is provided a recording medium storing a program, the program causing a computer to perform a process including:
determining whether or not a control based on an external input is necessary for a robot which executes a task; and
determining an operation terminal which generates the external input, based on operation terminal information, which includes information concerning types of a plurality of operation terminals to be candidates in order to generate the external input, and information concerning the task, when the control based on the external input is necessary.

### Effect of the Invention

It is possible to preferably determine an operation terminal which generates an external input.

### BRIEF DESCRIPTION OF THE DRAWINGS

FIG. 1 illustrates a configuration of a robot control system in a first example embodiment.

FIG. 2A illustrates a hardware configuration of a robot controller. FIG. 2B illustrates a hardware configuration of an operation terminal. FIG. 2C illustrates a hardware configuration of a robot management device.

FIG. 3 illustrates an example a data structure of application information.

FIG. 4A illustrates an example of a data structure of operation terminal information. FIG. 4B illustrates an example of a data structure of an operator information.

FIG. 5 illustrates an example of a functional block representing an overview of a process of the robot control system.

FIG. 6 illustrates an example of a functional block representing a functional configuration of an action sequence generation unit.

FIG. 7 illustrates a first display example of a task view.

FIG. 8 illustrates a second display example of the task view.

FIG. 9 illustrates an example of a flowchart performed by the robot management device in the first example embodiment.

FIG. 10 is a schematic diagram illustrating a robot management device in a second example embodiment.

FIG. 11 illustrates an example of a flowchart for explaining a process of the robot management device in the second example embodiment.

### EXAMPLE EMBODIMENTS

In the following, example embodiments will be described with reference to the accompanying drawings.

### First Example Embodiment

### (1) System Configuration

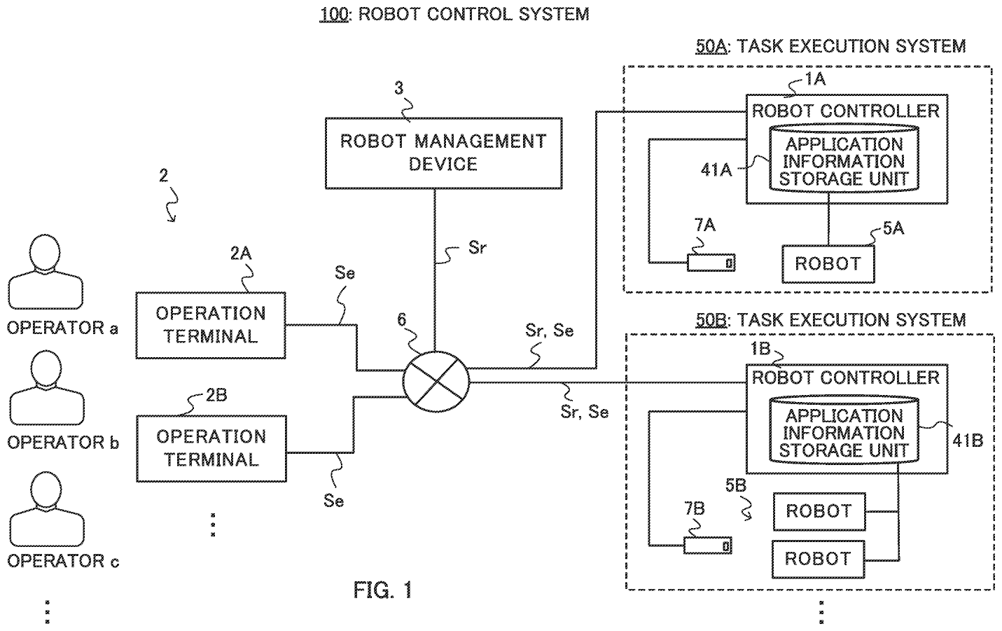

FIG. 1 illustrates a configuration of a robot control system 100 according to a first example embodiment. The robot control system 100 mainly includes a plurality of operation terminals 2 (2A, 2B, . . . ), a robot management device 3, and a plurality of task execution systems 50 (50A, 50B, . . . ). The plurality of operation terminals 2, the robot management device 3, and the plurality of task execution systems 50 perform data communications via a communication network 6.

Each of the operation terminals 2 is a terminal for receiving an assistance operation necessary for a robot 5 in a corresponding task execution system 50 to execute a task, and is used by one of operators (operators a to c, . . . ). In detail, in a case where there is an task execution system 50 which requests an assistance, the operation terminal 2 establishes a communication connection with the task execution system 50 based on a connection control by the robot management device 3, and transmits an external input signal “Se” generated by an operation (manual operation) of the operator to the task execution system 50 which is a request originator. Here, the external input signal Se is an input signal by the operator which represents a command for directly or indirectly defining an action of the robot 5 which needs an assistance.

In the present example embodiment, the operation terminals 2 include several types of terminals having different operation methods. For instance, each of the operation terminals 2 may be a tablet terminal, a stand-alone personal computer, a game controller, a virtual reality (VR: Virtual Reality) terminal, or the like. Accordingly, as described later, in a case where the task execution system 50 requesting the assistance exists, one operation terminal 2 having an appropriate type is selected as the operation terminal 2 which performs the assistance according to a content of a task to be assisted.

Note that one operation terminal 2 and one operator are not necessarily a one-to-one relationship, and there may be a case where one operation terminal 2 is used by several operators, a case where several operation terminals 2 are used by one operator, or another case. Moreover, the operation terminal 2 may further receive an input of the operator designating a task to be executed in the task execution system 50. In this case, the operation terminal 2 sends task designation information generated in response to the input, to the target task execution system 50.

The robot management device 3 manages a connection between the task execution system 50 which needs to be assisted by the operation terminal 2 and the operation terminal 2 which provides an assistance. In a case of receiving assistance request information “Sr” from any of the task execution systems 50, the robot management device 3 selects one operation terminal 2 (and one operator) suitable for assisting the task execution system 50 of the request originator, and executes the connection control for establishing a communication between the selected operation terminal 2 (also called an “applicable operation terminal 2”.) and the task execution system 50 of the request originator.

A communication mode between the task execution system 50 and the applicable operation terminal 2 may be a mode in which a data communication is performed directly by forming a VPN (Virtual Private Network) or the like, or may be a mode in which the data communication is indirectly carried out by having the robot management device 3 perform a transfer process of the data communication. In a former mode, for instance, the robot management device 3 as the connection control performs a process for transmitting another communication address to at least one of the task execution system 50 (more specifically a robot controller 1) or the applicable operation terminal 2 for a direct communicate between the task execution system 50 and the applicable operation terminal 2. In a latter mode, for instance, the robot management device 3 as the connection control performs a process for establishing a communication connection with each of the task execution system 50 and the applicable operation terminal 2 for a dedicated transfer.

The task execution systems 50 are robot systems which execute respective designated tasks, and are respectively provided in different environments. Each of the task execution systems 50 may be a system which performs a picking action at a factory (that is, picking out parts from a shelf and placing the picked parts into a tray, or the like) as a task, and may be any robot system at a location other than the factory. Examples of such the robot systems includes a robot system for performing a shelving action in a retail (that is, an action of arranging items in a container on a shelf at a store), an item check (that is, removing each expired item from the shelf or attaching a discount sticker to that item), and the like.

The task execution systems 50 respectively includes robot controllers 1 (1A, 1B, . . . ), robots 5 (5A, 5B, . . . ) and sensors 7 (7A, 7B, . . . ).

When a task is specified to be executed by the robot 5 belonging to the same task execution system 50, the robot controller 1 formulates an action plan of the robot 5 and controls the robot 5 based on the action plan. For instance, the robot controller 1 converts the task represented by a temporal logic into a sequence for each time step of the task which is to be a unit acceptable for the robot 5, and controls the robot 5 based on the generated sequence. Thereafter, a task (command) in which the robot 5 decomposes the task by the acceptable unit is referred to as a “subtask”, and a sequence of subtasks which the robot 5 executes in order to accomplish the task is referred to as a “subtask sequence” or an “action sequence”. As described later, the subtask includes a task which needs the assistance (that is, a manual control) by the operation terminal 2.

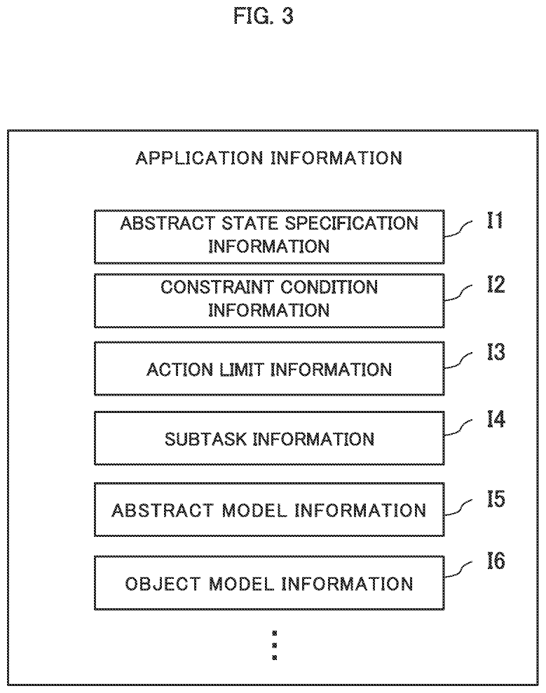

Moreover, the robot controllers 1 respectively include application information storage units 41 (41A, 41B, . . . for storing application information necessary for generating the action sequence of the robot 5 based on the task). Details of the application information will be described later with reference to FIG. 3.

Moreover, each of the robot controller 1 performs the data communication with the robot 5 and the sensor 7 which belong to the same task execution system 50 via the communication network or by a direct wireless or wired communication. For instance, the robot controller 1 sends a control signal related to the control of the robot 5, to the robot 5. In another example, the robot controller 1 receives a sensor signal generated by the sensor 7. Furthermore, the robot controller 1 performs data communication with the operation terminal 2 via the communication network 6.

One or more robots 5 exist for each of the task execution systems 50, and perform an action related to the task based on a control signal supplied from the robot controller 1 belonging to the same task execution system 50. Each of the robots 5 may be a vertically articulated robot, a horizontally articulated robot, or any other type of a robot, and may have a plurality of objects to be controlled (manipulators and end effectors) each of which operates independently such as a robot arm. Moreover, the robot 5 may be one which performs a cooperative operation with another robot, the operator, or a machine tool which operates in a workspace. Furthermore, the robot controller 1 and the robot 5 may be integrally formed.

Moreover, each of the robots 5 may supply a state signal indicating a state of that robot 5 to the robot controller 1 belonging to the same task execution system 50. The state signal may be an output signal of each sensor for detecting a state (a position, an angle, or the like) concerning the entire robot 5 or a specific part such as a joint of the robot 5, or may be a signal indicating a progress state of the action sequence supplied to the robot 5.

One or more sensors 7 include a camera, a range sensor, a sonar or a combination of these devices to detect a state in the workspace in which a task is performed in each task execution system 50. Each sensor 7 supplies the generated signal (also referred to as a “sensor signal”) to the robot controller 1 belonging to the same task execution system 50. Each sensor 7 may be a self-propelled or flying sensor (including a drone) which moves within the workspace. The sensors 7 may also include a sensor provided on the robot 5, sensors provided on other objects in the workspace, and other sensors. The one or more sensors 7 may also include a sensor which detects sound in the workspace. Thus, the one or more sensor 7 may include any of various sensors which detect the state in the workspace, and include sensors installed at any location.

Note that a configuration of the robot control system 100 illustrated in FIG. 1 corresponds to an example, and various changes may be made to the configuration. For instance, robot control functions of the robot controller 1 may be integrated into the robot management device 3. In this case, the robot management device 3 performs a generation of the action sequence for the robot 5 existing in each task execution system 50 and a control necessary for the robot 5 to execute the action sequence. In another example, the robot management device 3 may be formed by a plurality of devices. In this case, the plurality of devices forming the robot management device 3 exchange information necessary to execute a process assigned in advance among these devices. In yet another example, an application information storage unit 41 may be formed by one or more external storage devices which perform data communications with the robot controller 1. In this case, the external storage device may be one or more server devices for storing the application information storage unit 41 commonly referred to by the plurality of task execution systems 50.

### (2) Hardware Configuration

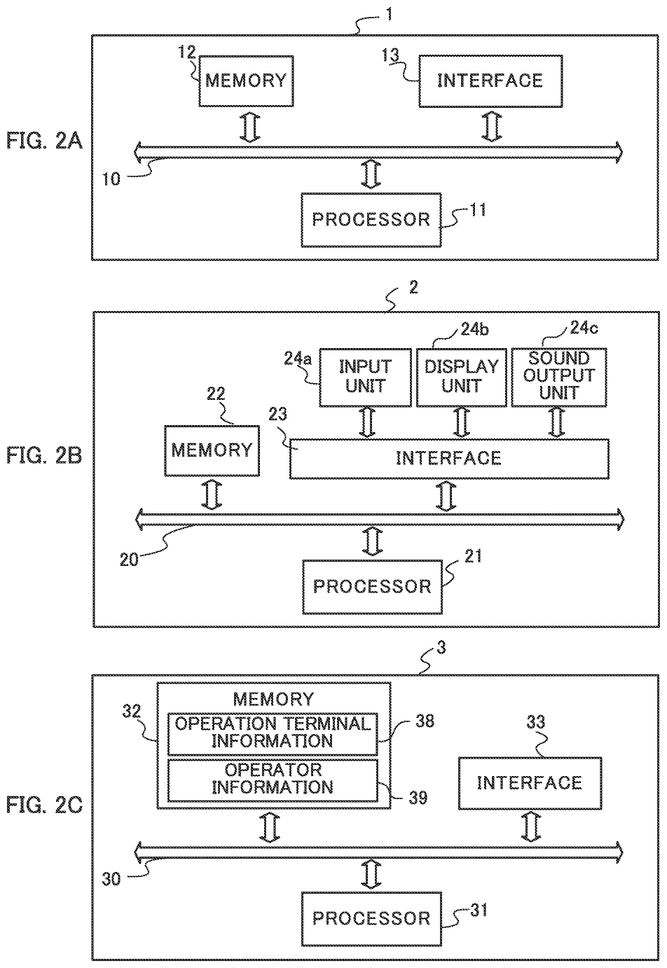

FIG. 2A illustrates a hardware configuration of the robot controller 1 (1A, 1B, . . . ). The robot controller 1 includes a processor 11, a memory 12, and an interface 13 as hardware. The processor 11, the memory 12 and the interface 13 are connected via a data bus 10.

The processor 11 functions as a controller (arithmetic unit) for performing overall control of the robot controller 1 by executing programs stored in the memory 12. The processor 11 is, for instance, a CPU (Central Processing Unit), a GPU (Graphics Processing Unit), a TPU (Tensor Processing Unit) or the like. The processor 11 may correspond to a plurality of processors.

The memory 12 is formed by various volatile and nonvolatile memories such as a RAM (Random Access Memory), a ROM (Read Only Memory), and a flash memory. Also, in the memory 12, programs for executing processes executed by the robot controller 1 are stored. Moreover, the memory 12 functions as the application information storage unit 41. Note that a part of information stored in the memory 12 may be stored by one or a plurality of external storage devices capable of communicating with the robot controller 1, or may be stored by a recording medium detachable from the robot controller 1.

The interface 13 is an interface for electrically connecting the robot controller 1 and other devices. The interface may be a wireless interface such as a network adapter for wirelessly transmitting and receiving data to and from other devices, or may be a hardware interface such as a cable which connects the other devices.

The hardware configuration of the robot controller 1 is not limited to the configuration depicted in FIG. 2A. For instance, the robot controller 1 may be connected to or incorporated in at least one of a display device, an input device, or a sound output device.

FIG. 2B illustrates a hardware configuration of the operation terminal 2. Each of the operation terminals 2 includes, as hardware, a processor 21, a memory 22, an interface 23, an input unit 24a, a display unit 24b, and a sound output unit 24c. The processor 21, the memory 22, and the interface 23 are connected via a data bus 20. Moreover, the interface 23 is connected to the input unit 24a, the display unit 24b, and the sound output unit 24c.

The processor 21 executes a predetermined process by executing a program stored in the memory 22. The processor 21 is a processor such as a CPU, a GPU, a TPU, or the like. Moreover, the processor 21 controls at least one of the display unit 24b or the sound output unit 24c through the interface 23 based on the information received from a corresponding task execution system 50 through the interface 23. Accordingly, the processor 21 presents information for supporting the operator regarding the operation to be performed. Moreover, the processor 21 transmits a signal generated by the input unit 24a to the task execution system 50 which is a sender of assistance request information Sr as the external input signal Se through the interface 23. The processor 21 may be formed by a plurality of processors. The processor 21 corresponds to an example of a computer.

The memory 22 is formed by any of various types of volatile memories such as a RAM, a ROM, a flash memory, a non-volatile memory, and the like. Moreover, programs for executing processes executed by the operation terminal 2 are stored in the memory 22.

The interface 23 is an interface for electrically connecting the operation terminal 2 and other devices. The interface may be a wireless interface such as a network adapter for wirelessly transmitting and receiving data to and from other devices, or may be a hardware interface such as a cable for connecting devices to other devices. Moreover, the interface 23 performs the interface operation of the input unit 24a, the display unit 24b and the sound output unit 24c.

The input unit 24a is an interface which receives inputs from a user, and for instance, a touch panel, a button, a keyboard, a voice input device, or the like corresponds to the input unit 24a. Depending on the type of the operation terminal 2, the input unit 24a includes an operation unit which receives an input of a user which represents a command directly defining an action of the robot 5. The operation unit may be, for instance, a controller (an operation panel) for the robot which is operated by the user in the control of the robot 5 based on an external input, may be an input system for the robot which generates an action command to the robot 5 in accordance with a movement of a user, or may be a game controller. The above-described controller for the robot includes, for instance, various buttons for designating a part or the like of the robot 5 to move and designating an action of the robot 5, and an operation bar for designating a movement direction. The robot input system described above includes, for instance, various sensors (including, for instance, a camera, a mounting sensor, and the like) used in a motion capture or the like.

The display unit 24b is, for instance, a display, a projector, or the like, and displays information based on the control of the processor 21. Also, the display unit 24b may be a combination of a combiner for realizing a virtual reality (a plate-shaped member with reflective and transmissive properties) and a light source for emitting a display light. Moreover, the sound output unit 24c is, for instance, a speaker, and outputs sound based on the control of the processor 21.

Note that the hardware configuration of the operation terminal 2 is not limited to the configuration depicted in FIG. 2B. For instance, at least one of the input unit 24a, the display unit 24b, or the sound output unit 24c may be formed as a separate device electrically connected to the operation terminal 2. Moreover, the operation terminal 2 may be connected to various devices including a camera which may be built in.

FIG. 2C illustrates a hardware configuration of the robot management device 3. The robot management device 3 includes a processor 31, a memory 32, and an interface 33 as hardware. The processor 31, the memory 32 and the interface 33 are connected via a data bus 30.

The processor 31 functions as a controller (arithmetic unit) for performing overall control of the robot management device 3 by executing programs stored in the memory 32. The processor 31 is, for instance, a processor such as the CPU, the GPU, or the TPU. The processor 31 may be formed by a plurality of processors. The processor 31 corresponds to an example of a computer.

The memory 32 may include various volatile and non-volatile memories such as the RAM, the ROM, the flash memory, and the like. Moreover, the memory 32 stores programs for executing processes executed by the robot controller 1. The memory 32 stores operation terminal information 38 which is information related to the operation terminal 2 available for the assistance with respect to the task execution system 50, and operator information 39 which is information concerning the operator who operates the operation terminal 2. Details of the operation terminal information 38 and the operator information 39 will be described later. The operation terminal information 38 and the operator information 39 may be information generated based on inputs of an administrator using an input unit (not illustrated) which is connected via the interface 33, may be stored in the memory 32, and may be information received from the operation terminal 2 or the like via the interface 33.

The interface 33 is an interface for electrically connecting the robot management device 3 and other devices. This interface may be a wireless interface, such as a network adapter for wirelessly transmitting and receiving data to and from other devices, or may be a hardware interface such as a cable for connecting devices to other devices.

Note that the hardware configuration of the robot management device 3 is not limited to the configuration depicted in FIG. 2C. For instance, the robot management device 3 may be connected to or incorporated in at least one of a display device, an input device, or a sound output device.

### (3) Data Structure

First, a data structure of the application information stored in each of the application information storage units 41 will be described.

FIG. 3 illustrates an example of the data structure of the application information. As illustrated in FIG. 3, the application information includes abstract state specification information I1, constraint condition information I2, action limit information I3, subtask information I4, abstract model information I5, and object model information I6.

The abstract state specification information I1 specifies an abstract state necessary to be defined for a creation of the action sequence. This abstract state is a state abstractly representing an object in a workspace and is defined as a proposition to be used in a target logical formula described below. For instance, the abstract state specification information I1 specifies the abstract state to be defined for each type of the task.

The constraint condition information I2 indicates a constraint condition for executing the task. For instance, in a case where the task is to pick and place, the constraint condition information I2 indicates a constraint condition that the robot 5 (robot arm) is not allowed to contact an obstacle, a constraint condition that the robots 5 (robot arms) are not allowed to contact each other, or another case. Note that the constraint condition information I2 may be information in which an appropriate constraint condition is recorded for each type of the task.

The action limit information I3 indicates information concerning an action limit of the robot 5 to be controlled by the robot controller 1. The action limit information I3 is, for instance, information defining an upper limit of speed, acceleration, or angular velocity of the robot 5. Note that the action limit information I3 may be information defining an action limit for each movable part or a joint of the robot 5.

The subtask information I4 indicates subtask information concerning a subtask which is a component of the action sequence. The “sub-task” is a partial task in which a task is decomposed by a unit acceptable for the robot 5, and indicates a subdivided action of the robot 5. For instance, in a case where the task is to pick and place, the subtask information I4 specifies reaching which refers to a movement of the robot arm of the robot 5 and grasping which refers to grasping by the robot arm, as the subtasks. The subtask information I4 may indicate information concerning available subtasks for each type of the task.

Moreover, the subtask information I4 also includes information concerning the subtask which need an action command being externally input (also called “external input type subtask”). In this case, the subtask information I4 concerning the external input type subtask includes, for instance, identification information of the subtask, flag information identifying whether or not the subtask is the external input type subtask, and information concerning the action content of the robot 5 in the external input subtask. In addition, the subtask information I4 concerning the external input type subtask may further include text information for requesting the external input from the operation terminal 2 and information concerning an estimated operation time length.

The abstract model information I5 is information concerning an abstract model abstractly representing dynamics in the workspace. For instance, the abstract model is represented by a model which abstracts real dynamics by a hybrid system, as will be described later. The abstract model information I5 includes information indicating a switching condition of the dynamics in the above-described hybrid system. For instance, in a case of the pick-and-place in which the robot 5 grasps and moves an object to be an action target (also referred to as a target object) of the robot 5 to a predetermined position, the switching condition corresponds to a condition that the target object is not moved unless the robot 5 grasps the target object. The abstract model information I5 includes information concerning the abstract model suitable for each type of the task.

The object model information I6 is information concerning the object model of each object in the workspace to be recognized based on signals generated by each sensor 7. Each of the above-described objects corresponds to, for instance, the robot 5, an obstacle, a tool, other objects handled by the robot 5, a working body other than the robot 5, and the like. The object model information I6 includes, for instance, information necessary for the robot controller 1 to recognize a type, a position, a posture, an action currently being executed, and the like, and three-dimensional shape information such as CAD (Computer Aided Design) data or the like for recognizing a three-dimensional shape of each object described above. The former information includes parameters of an inference engine obtained by learning a learning model in machine learning such as a neural network. For instance, in a case of inputting each image, the inference engine is trained in advance so as to output the type, the position, and the posture of the object to be a subject in the image.

Note that in addition to the above-described information, the application information storage unit 41 may store various types of information concerning a generation process of the action sequence and a display process necessary to receive an operation for generating the external input signal Se.

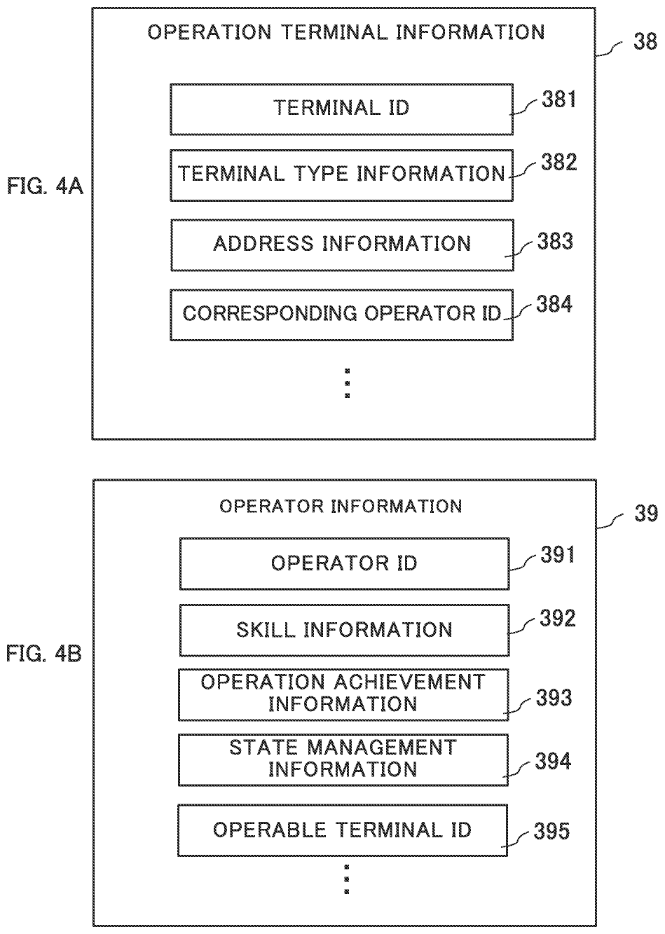

FIG. 4A is an example of a data structure of the operation terminal information 38. As illustrated in FIG. 4A, the operation terminal information 38 exists for each of the operation terminals 2, and mainly indicates a terminal ID 381, terminal type information 382, address information 383, and a corresponding operator ID 384.

The terminal ID 381 is a terminal ID of a corresponding operation terminal 2. The terminal ID 381 may be any identification information capable of identifying the operation terminal 2. The terminal type information 382 is information representing a terminal type of the corresponding operation terminal 2. The type of the operation terminal 2 is, for instance, classified based on a difference in a mode of the operation to be received.

The address information 383 is communication information necessary for communicating with the corresponding operation terminal 2, and is, for instance, information concerning a communication address necessary (including an IP address or the like) for a case of communicating in accordance with a predetermined communication protocol. The address information 383 is used, for instance, in the connection control for establishing a communication connection between the applicable operation terminal 2 and the corresponding task execution system 50. The corresponding operator ID 384 is identification information (operator ID) of the operator who operates the applicable operation terminal 2. The corresponding operator ID 384 may indicate the operators ID of several operators.

FIG. 4B illustrates an example of a data structure of the operator information 39. As illustrated in FIG. 4B, the operator information 39 exists for each operator registered as one who is able to assist for any of the task execution systems 50, and mainly includes an operator ID 391, skill information 392, operation achievement information 393, state management information 394, and an operable terminal ID 395.

The operator ID 391 is an operator ID of a corresponding operator. The skill information 392 is information representing a skill (skill level) of the operation using the operation terminal 2 by the corresponding operator. The skill information 392 may indicate the skill level of the operator for each type of the operation terminal 2 to be operated. The operation achievement information 393 is achievement information of the operator concerning the operation in response to an assistance request from any of the task execution systems 50. The operation achievement information 393 may indicate each operation achievement of the operator for respective types of the operation terminals 2 to be operated.

The operation achievement information 393 includes, for instance, the number of operations in response to the assistance requests from any of the task execution systems 50, a registration period (years of experience) as an operator, respective numbers or percentages of a success and failure due to the operations, and the like. Here, in a case of the assistance request from any of the task execution systems 50 due to an error occurrence, the “success and failure” are determined based on, for instance, whether or not an error at the task execution system 50 as the request originator has been solved by supplying the external input signal Se from the operation terminal. Note that in a case other than the error occurrence, the “success and failure” may be determined based on, for instance, whether or not the task has successfully completed after the external input signal Se is supplied from the operation terminal 2.

Note that the operation achievement information 393 may include an operation history generated for each operation in response to the assistance request from the task execution system 50. In this case, information concerning a task for which the assistance request has been supplied from the task execution system 50, information concerning the task execution system 50 of an assistance request originator, information indicating a date and time when the operation has been performed, and various types of information including an operation time length are recorded in the operation achievement information 393 as the operation history. For instance, the processor 31 updates the operation achievement information 393 based on the information received from the task execution system 50 of the request originator every time the assistance request and the assistance according to the request from the task execution system 50 are performed.

The state management information 394 is information related to a state management of the corresponding operator, and for instance, may be schedule information indicating a date and time or a time range within which the operator is available for the operation, or may be information indicating whether or not the operator is currently available (that is, present). The processor 31 may update the state management information 394 at a predetermined timing, for instance, upon receiving the schedule information, presence or absence information, and the like of each operator from another system for managing schedules of the operators, or upon receiving a manual input related to the state of each operator. Accordingly, the operation terminal information 38 and the operator information 39 are respectively updated at the necessary timing.

The operable terminal ID 395 is a terminal ID (the terminal ID 381 in FIG. 4A) of a terminal available to be operated by the corresponding operator. Note that, the operable terminal ID 395 may be a terminal ID of one operation terminal 2 or terminals ID of several operation terminals 2.

The data structures of the operation terminal information 38 and the operator information 39 are not limited to the data structures depicted in FIG. 4A and FIG. 4B. For instance, the operation terminal information 38 may further include information for managing the state of the operation terminal 2, which corresponds to the state management information 394 included in the operator information 39. Moreover, in a case where the operation terminal 2 and the operator are corresponded to by one-to-one, the operation terminal information 38 and the operator information 39 may be integrated in either one.

### (4) Functional Block

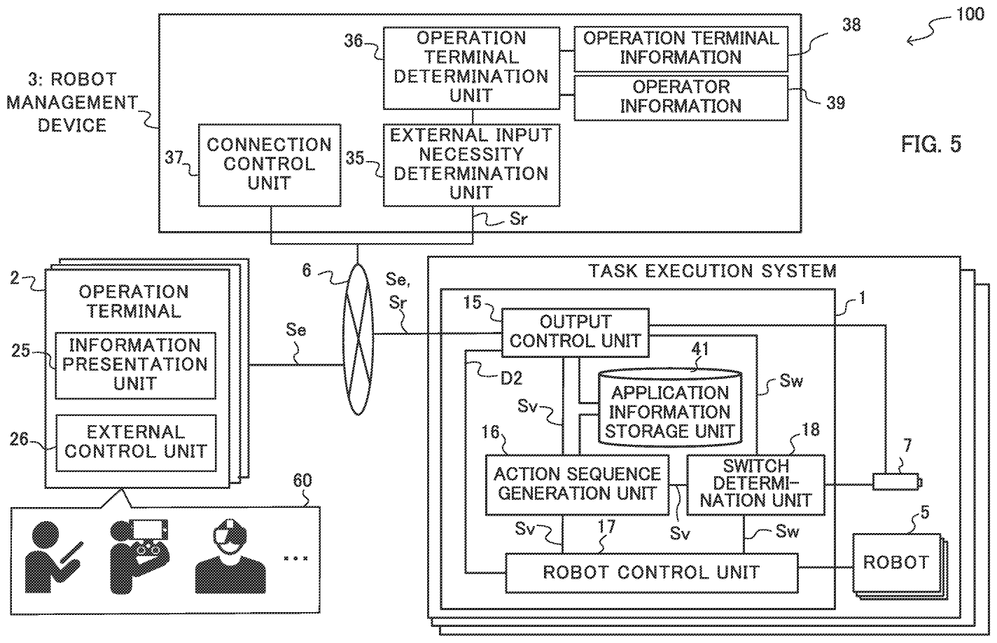

FIG. 5 is an example of a functional block illustrating an overview of a process by the robot control system 100. The processor 11 of each of the robot controllers 1 functionally includes an output control unit 15, an action sequence generation unit 16, a robot control unit 17, and a switching determination unit 18. Moreover, the processor 21 of each of the operation terminals 2 functionally includes an information presentation unit 25, and an external control unit 26. Furthermore, the processor 31 of the robot management device 3 functionally includes an external input necessity determination unit 35, an operation terminal determination unit 36, and a connection control unit 37. In the functional block illustrated in FIG. 5, blocks among which data are exchanged are connected by solid lines, but each combination of the blocks which perform a data exchange and the data to be exchanged are not limited as depicted in FIG. 5. The same applies to the drawings of other functional blocks described below. In addition, in FIG. 5, examples of operations by the operators at respective operation terminals 2 are illustrated in a balloon 60.

First, functions of the robot controller 1 will be described. The robot controller 1 controls the robot 5 based on the generated action sequence, and transmits the assistance request information Sr to the robot management device 3 when it is determined that the assistance by any of the operation terminals 2 is necessary. Accordingly, in order to accomplish the task, the robot controller 1 smoothly switches the control mode of the robot 5 to a control based on the external input signal Se (also referred to as an “external input control”) in a case where an automatic control alone is not possible to handle the task. In the following, functional components of the robot controller 1 will be described below.

The output control unit 15 performs a process related to sending of the assistance request information Sr and receiving of the external input signal Se through the interface 13. In this case, when a switching command “Sw” to the external input control is supplied from the switching determination unit 18, the output control unit 15 sends the assistance request information Sr for requesting a necessary external input to the operation terminal 2.

Here, the assistance request information Sr includes information concerning the task (subtask) which needs the assistance. Specifically, the assistance request information Sr includes, for instance, date and time information indicating a date and time when a request has been needed, type information of the robot 5 to be assisted, identification information of the task, identification information of the subtask to be assisted, an estimated work time length of the subtask, necessary action details of the robot 5, and error information concerning an error when the error occurs. The error information indicates an error code representing a type of the error. Note that the error information may include information representing a state at a time the error occurred (that is, video information) or the like. In addition, in a case where the communication connection between one operation terminal 2 and one robot controller 1 is established based on the connection control by the robot management device 3, the output control unit 15 transmits information (also referred to as “task view information”) necessary for displaying a task view for the operator using the operation terminal 2 to the operation terminal 2. Moreover, when receiving the external input signal Se from the operation terminal 2, the output control unit 15 supplies that external input signal Se to the robot control unit 17.

The action sequence generation unit 16 generates an action sequence “Sv” of the robot 5 necessary to complete a specified task based on a signal output from the sensor 7 and the application information. The action sequence Sv corresponds to a sequence of subtasks (subtask sequence) to be executed by the robot 5 in order to achieve the task, and defines a series of actions of the robot 5. Accordingly, the action sequence generation unit 16 supplies the generated action sequence Sv to the robot control unit 17 and the switching determination unit 18. Here, the action sequence Sv includes information indicating an execution order and execution timings for the subtasks.

The robot control unit 17 controls each action of the robot 5 by supplying the control signal to the robot 5 through the interface 13. The robot control unit 17 performs the control of the robot 5 after receiving the action sequence Sv from the action sequence generation unit 16. In this instance, the robot control unit 17 executes a position control, a torque control, and the like of the joint of the robot 5 for realizing the action sequence Sv by transmitting the control signal to the robot 5. Accordingly, the robot control unit 17 switches the control mode of the robot 5 to the external input control based on the switching command Sw supplied from the switching determination unit 18.

In the external input control, the robot control unit 17 receives the external input signal Se generated by the operation terminal 2 through the interface 13. For instance, the external input signal Se includes information defining a specific action of the robot 5 (for instance, information corresponding to the control input directly defining the action of the robot 5). Next, the robot control unit 17 generates the control signal based on the received external input signal Se, and controls the robot 5 by sending the generated control signal to the robot 5. The control signal generated by the robot control unit 17 in the external input control is, for instance, a signal obtained by converting the external input signal Se into a data format acceptable for the robot 5. Note that in a case where such this conversion process is performed in the robot 5, the robot control unit 17 may supply the external input signal Se as it is, to the robot 5 as the control signal.

Moreover, the external input signal Se may be information for assisting to recognize an operation state by any of the task execution systems 50, instead of information which defines the specific action of the robot 5. For instance, in one task execution system 50, when a target object to be picked and placed is no longer recognizable, the external input signal Se may be information indicating the position of the target object. In this instance, after establishing the communication connection with the task execution system 50, the corresponding operation terminal 2 receives images capturing a working environment from the task execution system 50, and receives an operation of an operator specifying the target object based on the images, thereby generating the external input signal Se specifying a region of the target object. After that, the robot control unit 17 recognizes the target object based on the external input signal Se, and resumes a robot control based on the interrupted action sequence.

Note that instead of the robot controller 1, the robot 5 may include a function corresponding to the robot control unit 17. In this case, the robot 5 operates based on the action sequence Sv generated by the action sequence generation unit 16, the switching command Sw generated by the switching determination unit 18, and the external input signal Se.

The switching determination unit 18 determines whether or not the switching of the control mode to the external input control is necessary, based on the action sequence Sv or the like. For instance, the switching determination unit 18 determines that switching of the control mode to the external input control is necessary when the execution timing of the external input type subtask incorporated in the action sequence Sv is reached. In another example, when the generated action sequence Sv is not executed as planned, the switching determination unit 18 considers that some kind of abnormality has occurred, and determines to need to switch the control of robot 5 to the external input control. In this case, for instance, the switching determination unit 18 determines that some kind of abnormality has occurred when detecting that a temporal or/and spatial deviation from the plan based on the action sequence Sv has occurred. The switching determination unit 18 may detect the occurrence of abnormality by receiving an error signal or the like from the robot 5 or by analyzing the sensor signal output by each sensor 7 (such as an image captured in the workspace). Next, when determining that the control mode is necessary to switch to the external input control, the switching determination unit 18 supplies the switching command Sw for instructing the switching of the control mode to the external input control, to the output control unit 15 and the robot control unit 17.

Next, the functional block of the operation terminal 2 will be described.

When the communication connection between the task execution system 50 which is the assistance request originator and the operation terminal 2 is established based on the connection control by the robot management device 3, the information presentation unit 25 displays the task view on the display unit 24b based on the task view information supplied from the task execution system 50 or the like. In the task view, for instance, information concerning the action contents of the robot 5 to be specified by the external input is displayed. Accordingly, the information presentation unit 25 presents information necessary for the operation to the operator. In this case, the information presentation unit 25 may output a voice guidance necessary for the operation by controlling the sound output unit 24c.

The external control unit 26 acquires a signal output by the input unit 24a in response to the operation by the operator referring to the task view as the external input signal Se, and sends the acquired external input signal Se to the task execution system 50 of the assistance request originator via the interface 23. In this case, for instance, the external control unit 27 acquires the external input signal Se and sends the external input signal Se in real time in response to the operation of the operator.

Next, a functional block of the robot management device 3 will be described.

The external input necessity determination unit 35 determines whether or not the assistance by the external input is necessary. In the present example embodiment, when the assistance request information Sr is received from the task execution system 50 through the interface 33, the external input necessity determination unit 35 determines that the assistance by the external input is necessary. Accordingly, the external input necessity determination unit 35 supplies the assistance request information Sr to the operation terminal determination unit 36.

The operation terminal determination unit 36 determines the operation terminal 2 and the operator assisting the task execution system 50 which is a transmission originator of the assistance request information Sr, based on the assistance request information Sr and the operation terminal information 38 (and the operator information 39). Detailed examples of this determination method will be described later.

The connection control unit 37 performs connection control for establishing the communication connection between the applicable operation terminal 2 determined by the operation terminal determination unit 36 and the task execution system 50 of the assistance request originator. In this case, the connection control unit 37 sends, to at least one of the applicable operation terminal 2 or the task execution system 50, a communication address of the other so that the applicable operation terminal 2 and the task execution system 50 directly establish the communication connection. In another example, the connection control unit 37 establishes the communication connection between the applicable operation terminal 2 and the task execution system 50 necessary for a transfer process of data exchanged between the applicable operation terminal 2 and the task execution system 50 during the external input control. In this instance, during the external input control, the connection control unit 37 performs a process which receives the external input signal Se or the like generated by the operation terminal 2 and transfers the received external input signal Se or the like to the task execution system 50 (more specifically, the robot controller 1), a process which receives the task view information or the like generated by the task execution system 50 and transfers the received task view information or the like to the operation terminal 2, and another process.

Here, for instance, it is possible to realize each component of the external input necessity determination unit 35, the operation terminal determination unit 36, and the connection control unit 37 by the processor 31 which executes corresponding programs. Moreover, necessary programs may be recorded on any non-volatile recording medium and installed as necessary to realize each component. Note that at least a part of these components may be implemented by any combination of hardware, firmware, and software, and the like without being limited to being implemented by software by the programs. At least a part of these components may also be implemented using user programmable integrated circuits such as a FPGA (Field-Programmable Gate Array), microcontroller, or the like. In this case, the integrated circuit may be used to realize a program formed by each of the above components. At least a part of the components may also be formed by an ASSP (Application Specific Standard Product), an ASIC (Application Specific Integrated Circuit), or a quantum computer control chip. As described above, each component may be implemented by any hardware in variety. The above is the same in other example embodiments described later. Furthermore, each of these components may be realized by a collaboration of a plurality of computers using, for instance, a cloud computing technology. The same applies to the components of the robot controller 1 and the operation terminal 2 illustrated in FIG. 5.

### (4) Details of a Process by the Operation Terminal Determination Unit

Next, a method for determining the applicable operation terminal 2 by the operation terminal determination unit 36 will be described. In brief, the operation terminal determination unit 36 determines the applicable operation terminal 2 by referring to information concerning the task included in the assistance request information Sr and at least the terminal type information 382 of the operation terminal information 38. In the following, this specific example will be described.

In a first example, the operation terminal determination unit 36 determines the operation terminal 2 which is to perform the assistance operation based on the type of the robot 5 of the task execution system 50 being the request originator and the terminal type information 382 of the operation terminal information 38. In general, different types of robots have different user interfaces which are easy to operate. Accordingly, the operation terminal determination unit 36 according to the first example selects the operation terminal 2 having the user interface suitable for the assistance operation of the robot 5 of the task execution system 50 which is the request originator. For instance, in a case where the target robot 5 is a robot arm, the operation terminal determination unit 36 selects the operation terminal 2 having a game controller as the user interface. In another example, when the target robot 5 is a humanoid robot, the operation terminal determination unit 36 selects the operation terminal 2 operable by VR.

Here, a supplemental explanation of the specific process in the first example will be provided. For instance, the memory 32 stores information in which each type of the operation terminal 2 is associated with a type of the operation terminal 2 suitable for the assistance operation (also referred to as “robot and operation terminal association information”). Accordingly, the operation terminal determination unit 36 refers to the robot and operation terminal association information, and recognizes the type of the operation terminal 2 suitable for the assistance operation based on the type of the robot 5 indicated by the assistance request information Sr. Subsequently, the operation terminal determination unit 36 specifies the operation terminal 2 corresponding to the type based on the terminal type information 382 included in the operation terminal information 38, and determines the specified operation terminal 2 as the applicable operation terminal 2.

Here, in a case where several operation terminals 2 selected based on the first example, the operation terminal determination unit 36 may determine the applicable operation terminal 2 based on one or more of a second example to a fourth example described below, or may determine the applicable operation terminal 2 by a random selection.

In the second example, instead of the first example or in addition to the first example, the operation terminal determination unit 36 determines the applicable operation terminal 2 based on the error information included in the assistance request information Sr and the terminal type information 382 of the operation terminal information 38. Accordingly, the operation terminal determination unit 36 preferably determines one operation terminal 2 for easy handling of the error which occurs, as the applicable operation terminal 2. For instance, the operation terminal determination unit 36 selects the operation terminal 2 having the game controller as the user interface in a case where the error information indicates that the grasping has failed in the pick-and-place. In another example, the operation terminal determination unit 36 selects the operation terminal 2 which is a personal computer in a case where the error information indicates that acquiring of product information has failed.

Here, a specific process of the second example will be supplementally described. For instance, the memory 32 stores information (also called “error and operation terminal association information”) associated with the type of the operation terminal 2 suitable for the assistance operation for each type of the error which may occur. The operation terminal determination unit 36 refers to the error and operation terminal association information, and recognizes the type of the operation terminal 2 suitable for the assistance operation from the type of the error indicated by the assistance request information Sr. Next, the operation terminal determination unit 36 specifies the operation terminal 2 corresponding to that type based on the terminal type information 382 included in the operation terminal information 38, and determines the specified operation terminal 2 as the applicable operation terminal 2.

Here, in a case there are several operation terminals 2 selected based on the second example, the operation terminal determination unit 36 may determine the applicable operation terminal 2 based on one or more of the first example, and the third example and the fourth example which will be described later, and may determine the applicable operation terminal 2 by the random selection.

Moreover, the operation terminal determination unit 36 may further perform a process for determining the applicable operation terminal 2 using the information included in the operation terminal information 38 or the operator information 39 other than the terminal type information 382, in addition to the terminal type information 382. These specific examples will be described as the third example and the fourth example. The following third example and fourth example are performed, for instance, in combination with the first example or the second example described above.

In the third example, the operation terminal determination unit 36 determines the operator based on the type of the error indicated by the assistance request information Sr. In this case, for instance, the memory 32 stores, for each type of error, information defining at least one of an achievement and a condition of a skill of the operator necessary for the assistance operation (also referred to as “error and operator association information”.). Accordingly, the operation terminal determination unit 36 refers to the error and operator association information, and recognizes the achievement and/or the skill of the operator necessary for the assistance operation from the type of the error indicated by the assistance request information Sr. Subsequently, the operation terminal determination unit 36 specifies one operator who satisfies the condition of the achievement and/or the skill with reference to the skill information 392 and/or the operation achievement information 393 included in the operator information 39, and determines the operation terminal 2 to be used by the specified operator as the applicable operation terminal 2.

In the fourth example, the operation terminal determination unit 36 determines, as the applicable operation terminal 2, the operation terminal 2 to be used by the operator in a state in which the assistance operation can be performed, based on the state management information 394. In this case, the operation terminal determination unit 36 refers to the state management information 394, specifies one operator able to assist at the present time, and determines the operation terminal 2 to be used by the specified operator as the applicable operation terminal 2. Accordingly, for instance, in a case where an overseas resident is included as the operator and the task execution system 50 is always in operation, it is possible for the operation terminal determination unit 36 to appropriately select one operator able to handle the task (that is, one operator residing in an area which is during working hours), and determine one operation terminal 2 to be used by the operator as the applicable operation terminal 2.

Next, a case will be supplementally described in which the applicable operation terminal 2 cannot be determined and the external input control cannot be started. Such the case corresponds to, for instance, a case where there is no applicable operation terminal 2 in attempting to select the applicable operation terminal 2 based on at least one of the above-described first example to fourth example, or the like.

In this case, for instance, the operation terminal determination unit 36 transmits information for prompting the robot control without external input control such as an autonomous recovery, to the task execution system 50 of the assistance request originator. In another example, the operation terminal determination unit 36 accumulates the assistance request information Sr for which the assistance has not yet been performed, and places the task execution system 50 of the assistance request originator in a standby state until the assistance is ready to be performed. In this case, the operation terminal determination unit 36 may sequentially process the assistance request information Sr in accordance with a FIFO (First In, First Out) method, determine each priority for pieces of the accumulated assistance request information Sr, and process the assistance request information Sr in order of priorities.

In this case, the operation terminal determination unit 36 determines each priority for pieces of the assistance request information Sr, based on a priority of the task based on information concerning the type of the task or the priority of the task included in the assistance request information Sr, or/and based on a level of urgency for the assistance or the like which is specified depending on a progress of the task in the task execution system 50 of the assistance request originator.

### (5) Details of the Action Sequence Generation Unit

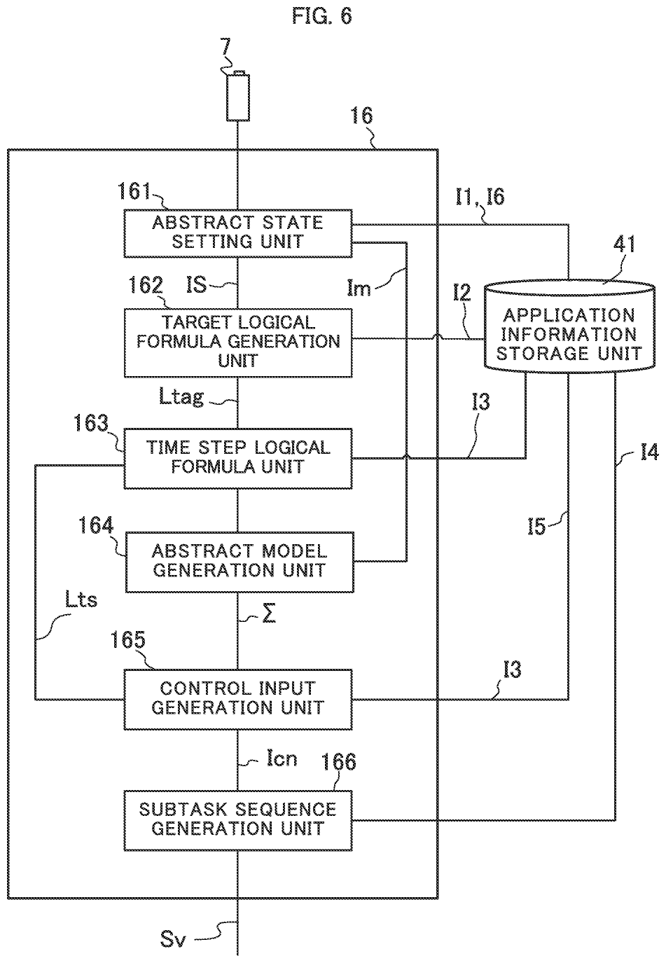

FIG. 6 is an example of a functional block illustrating a functional configuration of the action sequence generation unit 16. The action sequence generation unit 16 functionally includes an abstract state setting unit 161, a target logical formula generation unit 162, a time step logical formula generation unit 163, an abstract model generation unit 164, a control input generation unit 165, and a subtask sequence generation unit 166.

The abstract state setting unit 161 sets the abstract state in the workspace based on the sensor signal supplied from each sensor 7, the abstract state specification information I1, and the object model information I6. In this case, the abstract state setting unit 161 recognizes the object in the workspace which needs to be considered in executing the task, and generates a recognition result “Im” concerning the object. Next, the abstract state setting unit 161 defines a proposition for expressing each abstract state which needs to be considered when executing the task by a logical formula based on a recognition result Im. The abstract state setting unit 161 supplies information indicating the set abstract state (also called “abstract state setting information IS”), to the target logical formula generation unit 162.

Based on the abstract state setting information IS, the target logical formula generation unit 162 converts the task into a logical formula (also referred to as a “target logical formula Ltag”) of a temporal logic which represents a final achievement state. In this case, the target logical formula generation unit 162 refers to the constraint condition information I2 from the application information storage unit 41, and adds a constraint condition to be satisfied in executing the task to the target logical formula Ltag. Next, the target logical formula generation unit 162 supplies the generated target logical formula Ltag to the time step logical formula generation unit 163.

The time step logical formula generation unit 163 converts the target logical formula Ltag supplied from the target logical formula generation unit 162 into a logical formula (also referred to as a “time step logical formula Lts”) representing the state at every time step. The time step logical formula generation unit 163 supplies the generated time step logical formula Lts to the control input generation unit 165.

The abstract model generation unit 164 generates an abstract model “X” which abstractly represent the real dynamics in the workspace based on the abstract model information I5 stored in the application information storage unit 41 and the recognition result Im supplied from the abstract state setting unit 161. In this case, for instance, the abstract model E may be a hybrid system in which continuous dynamics and discrete dynamics are mixed as target dynamics. The abstract model generation unit 164 supplies the generated abstract model E to the control input generation unit 165.

The control input generation unit 165 satisfies the time step logical formula Lts supplied from the time step logical formula generation unit 163 and the abstract model Σ supplied from the abstract model generation unit 164, and determines the control input to the robot 5 for each time step to optimize an evaluation function (for instance, a function representing an amount of energy consumed by the robot). Next, the control input generation unit 165 supplies information (also referred to as “control input information Icn”) indicating the control input to the robot 5 at each time step, to the subtask sequence generation unit 166.

Based on the control input information Icn supplied from the control input generation unit 165 and the subtask information I4 stored in the application information storage unit 41, the subtask sequence generation unit 166 generates the action sequence Sv which is a sequence of subtasks, and supplies the action sequence Sv to the robot control unit 17 and the switching determination unit 18.

### (6) Task View

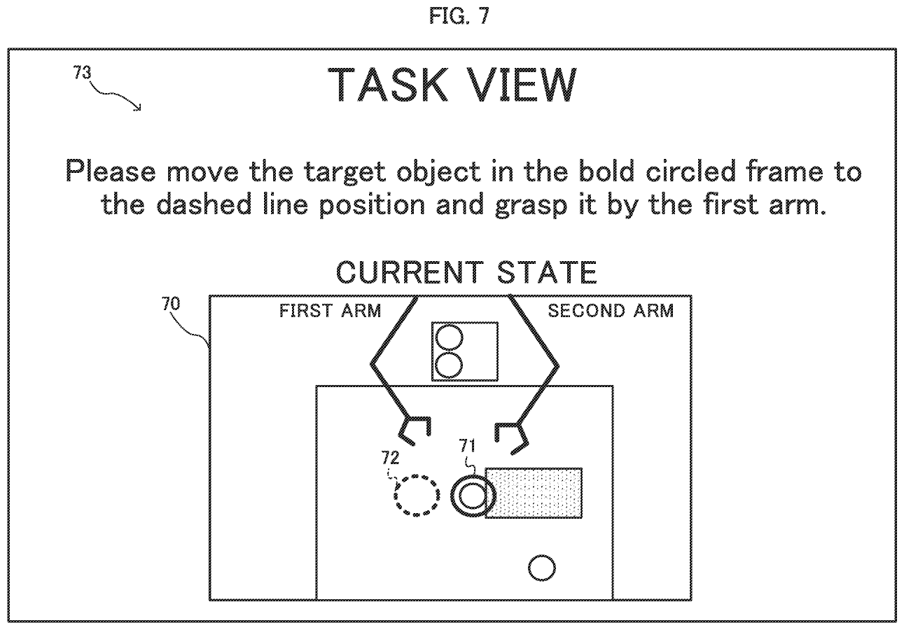

FIG. 7 illustrates a first display example of the task view displayed on the operation terminal 2. Upon receiving the task view information from the robot controller 1 of the task execution system 50 which is the sender of the assistance request information Sr, the information presentation unit 25 of the operation terminal 2 is controlled to display the task view depicted in FIG. 7. Here, at the execution timing of the external input type subtask (that is, an action step which needs the external input), the robot controller 1 sends the assistance request information Sr to the robot management device 3 in order to receive the external input signal Se necessary for the execution of the external input type subtask, and thereafter, establishes a communication connection with the operation terminal 2 based on the connection control by the robot management device 3. The task view illustrated in FIG. 7 mainly includes a workspace display field 70 and an operation content display area 73.

Here, the workspace display field 70 displays an image obtained by capturing a current workspace or a CAD image schematically representing the current workspace, and the operation content display area 73 displays a content which needs the robot 5 to operate by the external input. Here, as an example, it is assumed that a subtask to be operated is a subtask for moving a target object which cannot be directly grasped by the robot 5 because of being adjacent to the obstacle and grasping the object.

In the example in FIG. 7, the operation terminal 2 displays a guidance text instructing an operation content to be executed by the robot 5 (here, the target object is moved to a predetermined position and grasped by a first arm) on the operation content display area 73. Moreover, the operation terminal 2 displays, on a workspace image displayed in the workspace display field 70, a bold circle frame 71 surrounding the target object to be an action target, a dashed line round frame 72 indicating a movement destination of the target object, and a name of each of arms (the first arm and the second arm) of the robot 5. By adding such a display in the workspace display field 70, it is possible for the operation terminal 2 to make the operator, who refers to text of the operation content display area 73, suitably recognize the robot arm necessary for the action, as well as the target object to be the action target on and a destination of the target object.

Here, the operation content of the robot 5 illustrated in the operation content display area 73 is to satisfy the condition (also referred to as “sequence transition condition”) for transitioning from a current subtask to a next subtask. The sequence transition condition corresponds to the condition which indicates an end state (or a start state of the next subtask) of each subtask which is assumed in the generated action sequence Sv. The sequence transition condition in the example in FIG. 7 indicates that the first arm is in a state of grasping the target object at a predetermined position. Accordingly, by displaying the guidance text instructing the operation necessary to satisfy the sequence transition condition in the operation content display area 73, it is possible for the operation terminal 2 to suitably assist the external input necessary for smooth transition to the next subtask.

As described above, according to the task view illustrated in FIG. 7, at the execution of the external input type subtask for which the external input control is necessary, it is possible to accept an appropriate operation by the operator.

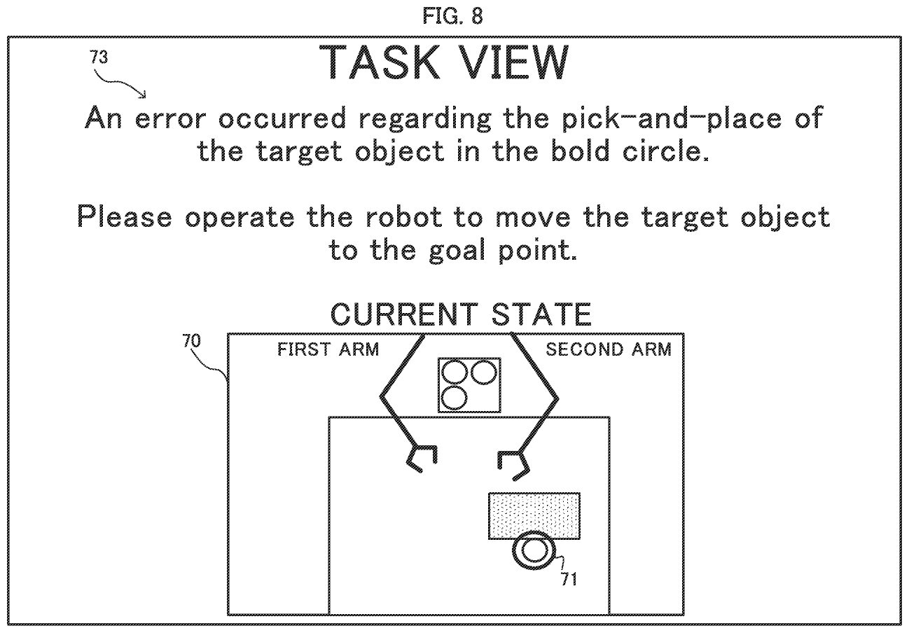

FIG. 8 illustrates a second display example of the task view. The information presentation unit 25 of the operation terminal 2 receives the task view information from the robot controller 1 of the task execution system 50 of the sender of the assistance request information Sr, and controls the task view illustrated in FIG. 8 to be displayed. The task view illustrated in FIG. 8 mainly has the workspace display field 70 and the operation content display area 73.

In the second display example, one target object has rolled behind an obstacle due to some accident, and the target object is unable to be directly grasped by the robot arm. In this case, the robot controller 1 determines that it is unsuitable to continue the robot control in autonomy due to a detection of a temporal or/and spatial deviation from the plan based on the action sequence Sv, sends the assistance request information Sr to the robot management device 3, and then sends the task view information to the operation terminal 2 with which the communication connection has been established.

Next, as illustrated in FIG. 8, the information presentation unit 25 displays, on the operation content display area 73, that an abnormality has occurred with respect to the pick-and-place of the object, and that an external input for moving the target object to the goal point is necessary. Moreover, the output control unit 15 displays, on the image displayed in the workspace display field 70, the bold circle frame 71 surrounding the target object to be the action target, a name of each of the arms of the robot 5 (the first arm and the second arm).

Therefore, according to the task view illustrated in FIG. 8, when the external input control becomes necessary due to the occurrence of abnormality, it is possible to accept appropriate operations by the operator when the external input control is necessary due to the occurrence of the abnormality. Note that the operation terminal 2 may output a guidance voice instructing operations for generating the necessary external input signal Se, along with displaying the task views in FIG. 7 and FIG. 8.

### (7) Process Flow

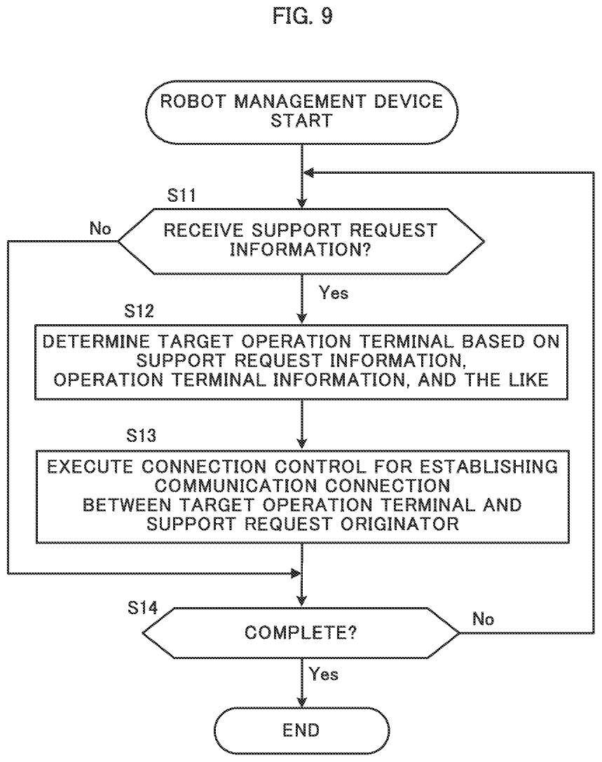

FIG. 9 illustrates an example of a flowchart for explaining an overview of a process executed by the robot management device 3 in the first example embodiment.

First, the external input necessity determination unit 35 of the robot management device 3 determines whether or not the assistance request information Sr has been received (step S11). When it is determined that the assistance request information Sr has been received (step S11; Yes), the external input necessity determination unit 35 advances the process to step S12. Next, the operation terminal determination unit 36 of the robot management device 3 determines the applicable operation terminal 2 based on the assistance request information Sr, the operation terminal information 38, and the like (step S12). Note that the operation terminal determination unit 36 may further refer to the operator information 39 in addition to the operation terminal information 38, and perform a process for determining an operator suitable for the assistance operation.

Next, the connection control unit 37 of the robot management device 3 performs the connection control for establishing a communication connection between the applicable operation terminal 2 and the task execution system 50 which is the request originator (step S13). Accordingly, the connection control unit 37 establishes a communication connection between the determined applicable operation terminal 2 and the task execution system 50 which is the request originator. After that, the determined applicable operation terminal 2 and the task execution system 50 which is the request originator exchange the task view information, the external input signal Se, and the like.

After step S13 is performed or when the assistance request information Sr has not received yet in the step S11 (step S11; No), the robot management device 3 determines whether or not to terminate the process of the flowchart (step S14). For instance, the robot management device 3 determines that the process of the flowchart is to be terminated when the robot control system 100 is out of running hours or when or when another predetermined termination condition is satisfied. Next, when the process of the flowchart is to be terminated (step S14; Yes), the robot management device 3 terminates the process of the flowchart. On the other hand, when the process of the flow chart is not to be terminated, the robot manager 3 returns the process to the step S11 (step S14; No).

### (8) Modification

The block configuration of the action sequence generation unit 16 illustrated in FIG. 6 is an example, and various changes may be made.

For instance, information of candidates of the sequence of actions to be instructed to the robot 5 is stored in advance in the storage device 4, and the action sequence generation unit 16 may perform an optimization process of the control input generation unit 165 based on the information of the candidates. Thus, the action sequence generation unit 16 performs selection of an optimum candidate and determination of the control input of the robot 5. In this case, the action sequence generation unit 16 may not include a function corresponding to the abstract state setting unit 161, the target logical formula generation unit 162, and the time step logical formula generation unit 163 in generating the action sequence Sv. As described above, information concerning an execution result of a part of the functional blocks of the action sequence generation unit 16 illustrated in FIG. 6 may be stored in advance in the application information storage unit 41.

In another example, the application information includes design information such as a flowchart for designing the action sequence Sv corresponding to the task in advance, and the action sequence generation unit 16 may generate the action sequence Sv by referring to the design information. Note that for instance, Japanese Laid-open Patent Publication No 2017-39170 discloses a specific example of executing the task based on a task sequence designed in advance.

### Second Example Embodiment

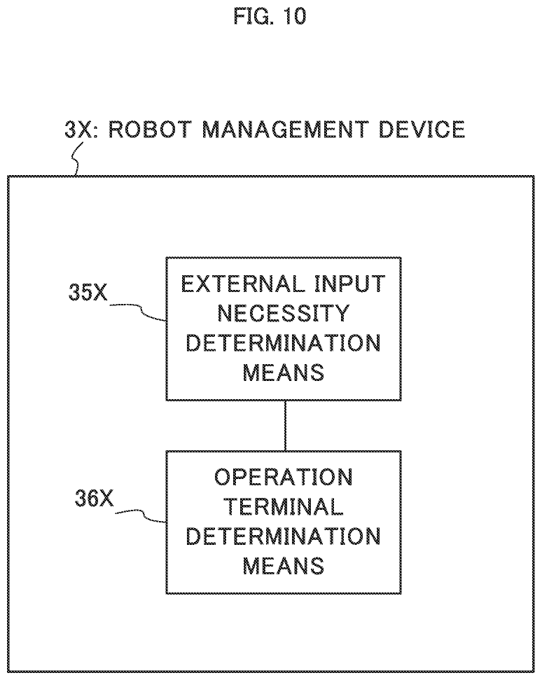

FIG. 10 illustrates a schematic configuration diagram of a robot management device 3X according to the second example embodiment. The robot management device 3X mainly includes an external input necessity determination means 35X and an operation terminal determination means 36X. Note that the robot management device 3X may be formed by a plurality of devices. For instance, it is possible for the robot management device 3X to be the robot management device 3 of the first example embodiment (including a case where a part of functions of the robot controller 1 is incorporated).

The external input necessity determination means 35X determines whether or not the control (external input control) based on the external input of the robot which performs the task is necessary. For instance, it is possible for the external input necessity determination means 35X to be the external input necessity determination unit 35 in the first example embodiment.

In a case where the control based on the external input is necessary, the operation terminal determination means 36X determines one operation terminal which generates the external input based on the operation terminal information including information concerning a plurality of types of operation terminals to be candidates for generating the external input and information concerning the task. The “information concerning the task” includes various information included in the assistance request information Sr of the first example embodiment such as the information concerning the type of the task, information concerning the robot which executes the task, information concerning an error occurred in the task, and the like. For instance, it is possible for the operation terminal determination means 36X to be the operation terminal determination unit 36 in the first example embodiment.

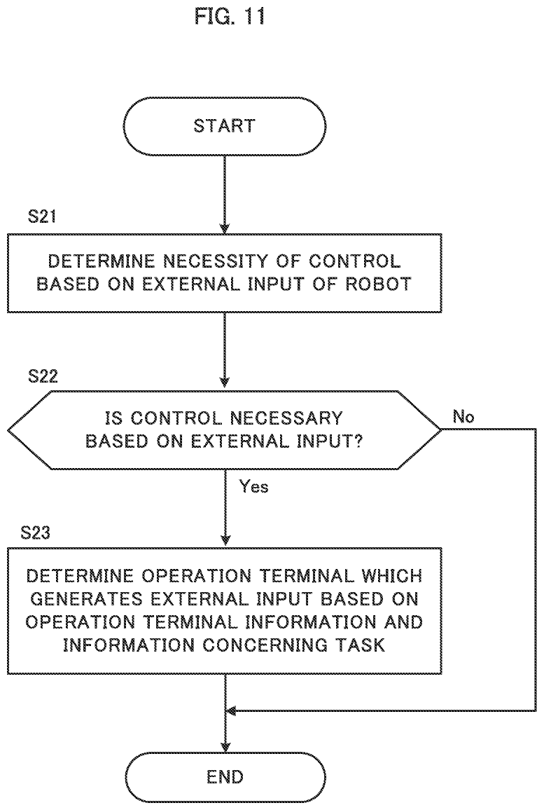

FIG. 11 is an example of a flowchart in the second example embodiment. The external input necessity determination means 35X determines whether or not the control based on the external input of the robot which executes the task is necessary (step S21). When the control based on an external input is necessary (step S22; Yes), the operation terminal determination means 36X determines one operation terminal which generates the external input based on the operation terminal information including information concerning the plurality of types of operation terminals which are to be the candidates for generating the external input and the information concerning the task (step S23). On the other hand, when the control based on the external input is not necessary (step S22; No), the operation terminal determination means 36X does not perform a process of step S23 and terminates the process of the flowchart.

According to the second example embodiment, it is possible for the robot management device 3X to suitably determine one operation terminal which generates the external input in a case where there is a robot which needs the control based on the external input.

In the example embodiments described above, the program is stored by any type of a non-transitory computer-readable medium (Non-Transitory Computer Readable Medium) and can be supplied to a processor or the like that is a computer. The non-transitory computer-readable medium may be any type of a tangible storage medium. Examples of the non-transitory computer readable medium include a magnetic storage medium (that is, a flexible disk, a magnetic tape, a hard disk drive), a magnetic-optical storage medium (that is, a magnetic optical disk), a CD-ROM (Read Only Memory), a CD-R, a CD-R/W, a solid-state memory (that is, a mask ROM, a PROM (Programmable ROM), an EPROM (Erasable PROM), a flash ROM, and a RAM (Random Access Memory)). Moreover, the program may be provided to the computer by any type of a transitory computer readable medium. Examples of the transitory computer readable medium include an electrical signal, an optical signal, and an electromagnetic wave. The transitory computer readable medium can provide the programs to the computer through a wired channel such as a cable or an optical fiber, or a wireless channel.

A part or all of the example embodiments described above may also be described as the following supplementary notes, but not limited thereto.

(Supplementary Note 1)

A robot management device comprising:
an external input necessity determination means configured to determine whether or not a control based on an external input is necessary for a robot which executes a task; and
an operation terminal determination means configured to determine an operation terminal which generates the external input, based on operation terminal information, which includes information concerning types of a plurality of operation terminals to be candidates in order to generate the external input, and information concerning the task, when the control based on the external input is necessary.

(Supplementary Note 2)

The robot management device according to supplementary note 1, further comprising a connection control means configured to control establishing of a communication connection between the operation terminal which is determined by the operation terminal determination means and the robot or a robot controller which controls the robot.

(Supplementary Note 3)

The robot management device according to supplementary note 1 or 2, wherein
the information concerning the task includes error information concerning an error occurred in the task, and
the operation terminal determination means determines the operation terminal which generates the external input, based on the operation terminal information and the error information.

(Supplementary Note 4)

The robot management device according to any one of supplementary notes 1 to 3, wherein
the information concerning the task includes type information of the robot, and
the operation terminal determination means determines the one operation terminal which generates the external input, based on the operation terminal information and the type information of the robot.

(Supplementary Note 5)

The robot management device according to any one of supplementary notes 1 to 4, wherein the operation terminal determination means determines the operation terminal which generates the external input, based on operator information which is information concerning an operator for each operation terminal, the operator terminal information, and the information concerning the task.

(Supplementary Note 6)

The robot management device according to supplementary note 5, wherein
the operator information includes a skill of each operator or information concerning an operation achievement, and
the operation terminal determination means determines one operation terminal used by an operator who satisfies a necessary skill or achievement defined based on the information concerning the task, as the operation terminal which generates the external input.

(Supplementary Note 7)

The robot management device according to supplementary note 5 or 6, wherein
the operator information includes state management information which is information concerning a state management of each operator, and
the operator terminal determination means determines one operation terminal used by an operator who is available to perform an operation concerning the external input as the operation terminal which generates the external input based on the state management information.

(Supplementary Note 8)

The robot management device according to any one of supplementary notes 1 to 7, wherein the external input necessity determination means determines that the control based on the external input is necessary, in a response to receiving of assistance request information including information concerning the task from the robot or a robot controller which controls the robot.

(Supplementary Note 9)

The robot management device according to any one of supplementary notes 1 to 8, wherein the external input necessity determination means determines that the control based on the external input is necessary in response to an occurrence of an error in an execution of the task by the robot or in response to an operation step in which the external input is necessary.

(Supplementary Note 10)

A control method performed by a computer, the control method comprising:
determining whether or not a control based on an external input is necessary for a robot which executes a task; and
determining an operation terminal which generates the external input, based on operation terminal information, which includes information concerning types of a plurality of operation terminals to be candidates in order to generate the external input, and information concerning the task, when the control based on the external input is necessary.

(Supplementary Note 11)

A recording medium storing a program, the program causing a computer to perform a process comprising:
determining whether or not a control based on an external input is necessary for a robot which executes a task; and
determining an operation terminal which generates the external input, based on operation terminal information, which includes information concerning types of a plurality of operation terminals to be candidates in order to generate the external input, and information concerning the task, when the control based on the external input is necessary.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF SYMBOLS

1, 1A, 1B Robot controller
2, 2A, 2B Operation terminal
3, 3X Robot management device
5 Robot
7 Sensor
41 Application information storage unit
100 Robot control system

What is claimed is:

1. A robot management device comprising:
a memory storing instructions; and
one or more processors configured to execute the instructions to:
determine whether or not a control based on an external input is necessary for a robot which executes a task, and
an operation terminal which generates the external input, based on operation terminal information, which includes information concerning types of a plurality of operation terminals to be candidates in order to generate the external input, and information concerning the task, when the control based on the external input is necessary.

2. The robot management device according to claim 1, wherein the processor is further configured to control establishing of a communication connection between the operation terminal which is determined in determining of the operation terminal and the robot or a robot controller which controls the robot.

3. The robot management device according to claim 1, wherein
the information concerning the task includes error information concerning an error occurred in the task, and
the processor determines the operation terminal which generates the external input, based on the operation terminal information and the error information.

4. The robot management device according to claim 1, wherein
the information concerning the task includes type information of the robot, and
the processor determines the one operation terminal which generates the external input, based on the operation terminal information and the type information of the robot.

5. The robot management device according to claim 1, wherein the processor determines the operation terminal which generates the external input, based on operator information which is information concerning an operator for each operation terminal, the operator terminal information, and the information concerning the task.

6. The robot management device according to claim 5, wherein
the operator information includes a skill of each operator or information concerning an operation achievement, and
the processor determines one operation terminal used by an operator who satisfies a necessary skill or achievement defined based on the information concerning the task, as the operation terminal which generates the external input.

7. The robot management device according to claim 5, wherein
the operator information includes state management information which is information concerning a state management of each operator, and
the processor determines one operation terminal used by an operator who is available to perform an operation concerning the external input as the operation terminal which generates the external input based on the state management information.

8. The robot management device according to claim 1, wherein the processor determines that the control based on the external input is necessary, in a response to receiving of assistance request information including information concerning the task from the robot or a robot controller which controls the robot.

9. The robot management device according to claim 1, wherein the processor determines that the control based on the external input is necessary in response to an occurrence of an error in an execution of the task by the robot or a step in which external input is necessary.

10. A control method performed by a computer, the control method comprising:
determining whether or not a control based on an external input is necessary for a robot which executes a task; and
determining an operation terminal which generates the external input, based on operation terminal information, which includes information concerning types of a plurality of operation terminals to be candidates in order to generate the external input, and information concerning the task, when the control based on the external input is necessary.

11. A non-transitory computer readable recording medium storing a program, the program causing a computer to perform a process comprising:
determining whether or not a control based on an external input is necessary for a robot which executes a task; and
determining an operation terminal which generates the external input, based on operation terminal information, which includes information concerning types of a plurality of operation terminals to be candidates in order to generate the external input, and information concerning the task, when the control based on the external input is necessary.
